(19) United States
(12) Patent Application Publication
(10) Pub. No.: US 2015/0090660 A1
(43) Pub. Date: Apr. 2, 2015

(54) Light-Assisted Membrane Treatment and Cleaning

(71) Applicant: University of Alaska Anchorage, Anchorage, AK (US)

(72) Inventor: Aaron Dotson, Anchorage, AK (US)

(21) Appl. No.: 14/503,306

(22) Filed: Sep. 30, 2014

Related U.S. Application Data
(60) Provisional application No. 61/884,864, filed on Sep. 30, 2013.

(51) Int. Cl. C02F 1/32; C02F 1/44; B01D 69/04; B01D 71/04; B01D 61/14; B01D 65/02

(52) U.S. Cl. CPC C02F 1/32; B01D 61/147; B01D 65/02; B01D 69/04; B01D 71/04; C02F 1/442; C02F 1/444; B01D 2311/2619; B01D 2321/168; B01D 2321/343; C02F 2101/30
USPC 210/636; 210/638; 210/251; 29/428

(57) ABSTRACT

In one aspect, the invention relates to a filtration apparatus comprising a tubular inorganic porous membrane and a light source disposed within the lumen of the membrane for use in, for example, enhancing oxidation of organic molecules and enhancing foulant removal. In one aspect, the invention relates to a filtration apparatus comprising a tubular porous membrane and a displacement body disposed within the lumen of the membrane. This abstract is intended as a scanning tool for purposes of searching in the particular art and is not intended to be limiting of the present invention.

### CROSS-REFERENCE TO RELATED APPLICATIONS

This application claims the benefit of U.S. Provisional Application No. 61/884,864, filed on Sep. 30, 2013, which is incorporated herein by reference in its entirety.

### BACKGROUND

The use of membranes in drinking water treatment, wastewater treatment, and industrial water treatment has rapidly increased in the past decade. With this rapid increase, on-going research has focused on a variety of aspects including membrane material type, pore structure, surface functionality, impregnation or modification with foreign particles (e.g. nanoparticles), fouling, and pretreatment. In many ways, this research has either directly or indirectly attempted to exploit synergies between chemical and physical properties of the membrane system.

One such combination has been application of oxidants upstream of membranes. This has been made possible due to the advent of new membranes that are resistant to oxidants such as chlorine. On the other hand, the membrane material most likely to be utilized for broad scale commercial application is able to be strongly oxidized; these are ceramic membranes. Ceramic membranes are made in flat plates or tubular configurations with pore sizes ranging from 1 kDa to multiple microns. These membranes are commonly made of titania, alumina, or zirconia oxides. Beyond their ability to withstand strong oxidants, they are also able to resist many strong acids, bases, and solvents.

Prior research has mainly emphasized single use chemicals to degrade foulants and microorganisms. Implementation of these technologies requires significant pre-treatment to ensure successful operation. Multiple processes are thus included as part of a train, making these processes complex to operate. Additionally, handling treatment residuals is an extreme challenge of small systems, and as such, need to be considered. Synergistic processes that would allow for improved production (e.g. increased throughput at lower pumping cost) without the use of single use chemicals are therefore desirable.

### SUMMARY

In one aspect, the invention relates to a filtration apparatus comprising: (a) a tubular inorganic porous membrane having an interior surface, an exterior surface, and a lumen extending there through; and (b) a light source disposed within the lumen of the tubular inorganic porous membrane; wherein the membrane is configured to receive an inflow liquid into the lumen, between the light source and the interior surface; and wherein the membrane is configured to produce an outflow liquid at the exterior surface from the inflow liquid passing through.

In one aspect, the invention relates to a filtration apparatus comprising: (a) a tubular porous membrane having an interior surface, an exterior surface, and a lumen extending there through; and (b) a displacement body disposed within the lumen of the tubular porous membrane; wherein the membrane is configured to receive an inflow liquid into the lumen, between the displacement body and the interior surface; and wherein the membrane is configured to produce an outflow liquid at the exterior surface from the inflow liquid passing through.

Also disclosed are methods of making a filtration apparatus, the method comprising disposing a light source within the lumen of a tubular inorganic porous membrane configured to receive an inflow liquid into the lumen, between the light source and the interior surface, and to produce an outflow liquid at the exterior surface from the inflow liquid passing through.

Also disclosed are methods of making a filtration apparatus, the method comprising disposing a displacement body within the lumen of a tubular porous membrane configured to receive an inflow liquid into the lumen, between the light source and the interior surface, and to produce an outflow liquid at the exterior surface from the inflow liquid passing through.

In various aspects, the invention relates to a method for enhancing oxidation of organic molecules, the method comprising the steps of: (a) providing a filtration apparatus as disclosed herein; (b) circulating the organic molecules in solution through the lumen of the filtration membrane, between the light source and the interior source; and (c) irradiating the filtration membrane with the light source.

In various aspects, the invention relates to a method for enhancing oxidation of inorganic molecules, the method comprising the steps of: (a) providing a filtration apparatus as disclosed herein; (b) circulating the inorganic molecules in solution through the lumen of the filtration membrane, between the light source and the interior source; and (c) irradiating the filtration membrane with the light source.

In various aspects, the invention relates to method for enhancing foulant removal, the method comprising the steps of: (a) providing a filtration apparatus as disclosed herein, wherein the membrane has a foulant cake layer at the surface; (b) loading a photocatalyst onto the foulant cake layer; (c) passing an inflow liquid through the lumen of the membrane, while circulating fluid between the light source and the interior support; and (d) irradiating the filtration membrane with the light source.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 shows a plan view (1A) and a section view (1B) of a filtration apparatus configuration comprising a tubular ceramic membrane and a light source disposed within the lumen of the membrane.

FIG. 2 shows a representative photograph of a filtration apparatus system.

FIGS. 3A and 3B show representative data pertaining to the transmembrane pressure (TMP) (3A) and filtrate flow (3B) of the filtration apparatus over time during an organic matter fouling experiment illustrating the decrease in fouling rate at about 14:50 due to ultraviolet (UV) irradiation of the membrane surface.

FIG. 4 shows representative data pertaining to the performance of a 15 kDa membrane in a critical flux test without UV irradiation.

FIG. 5 shows representative data pertaining to membrane flux (solid) and the degradation of organic pollutants at each test condition.

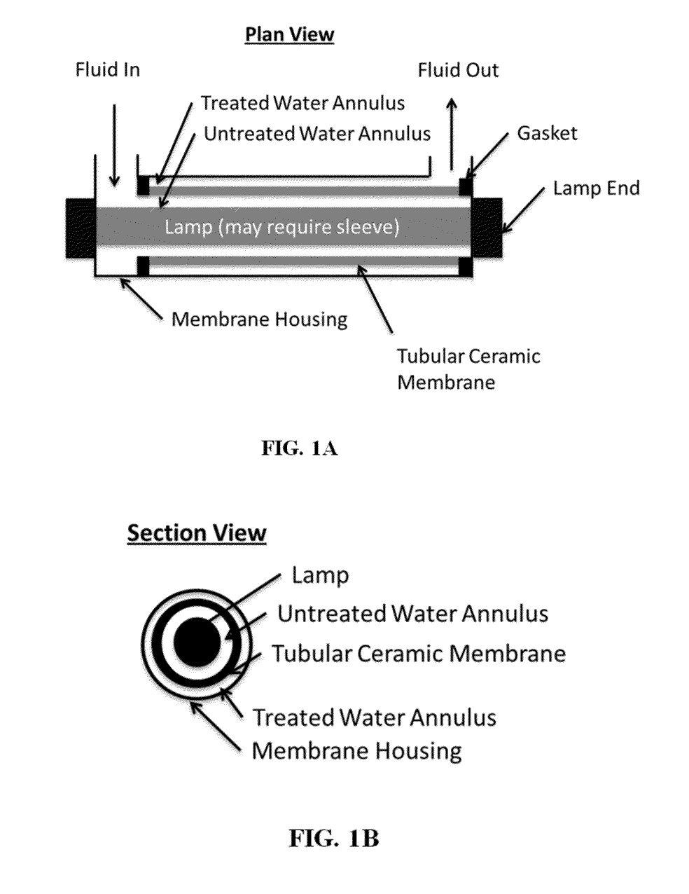

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

### A. DEFINITIONS

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a functional group,” “an alkyl,” or “a residue” includes mixtures of two or more such functional groups, alkyls, or residues, and the like.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or cannot occur, and that the description includes instances where said event or circumstance occurs and instances where it does not.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplemental volumes (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. FILTRATION APPARATUS

In one aspect, the filtration apparatus of the invention can comprise: (a) a tubular inorganic porous membrane having an interior surface, an exterior surface, and a lumen extending there through; and (b) a light source disposed within the lumen of the tubular inorganic porous membrane; wherein the membrane is configured to receive an inflow liquid into the lumen, between the light source and the interior surface, and wherein the membrane is configured to produce an outflow liquid at the exterior surface from the inflow liquid passing through.

In one aspect, the filtration apparatus of the invention can comprise: (a) a tubular porous membrane having an interior surface, an exterior surface, and a lumen extending there through; and (b) a displacement body disposed within the lumen of the tubular inorganic porous membrane; wherein the membrane is configured to receive an inflow liquid into the lumen, between the displacement body and the interior surface; and wherein the membrane is configured to produce an outflow liquid at the exterior surface from the inflow liquid passing through.

1. Tubular Porous Membranes

In one aspect, the membranes of the invention are tubular porous membranes. In a further aspect, the membranes of the invention are inorganic. In a still further aspect, the membranes of the invention are organic. In yet a further aspect, the membranes of the invention are ceramic. In an even further aspect, the membranes of the invention are polymeric.

In various aspects, the membrane is made up of at least one porous support. The support is generally a thick, very porous structure that provides mechanical strength to the membrane element without significant flow resistance. The support may be composed of ceramics, glass ceramics, glasses, metals, polymerics, and combinations thereof. Examples of these include, but are not limited to metals, such as stainless steel, metal oxides, such as alumina (e.g., alpha-aluminas, delta-aluminas, gamma-aluminas, or combinations thereof), cordierite, mullite, aluminum titanate, titania, zeolite, ceria, magnesia, silicon carbide, zirconia, zircon, zirconates, zirconia-spinel, spinel, silicates, borides, alumino-silicates, porcelain, lithium alumino-silicates, feldspar, magnesium alumino-silicates, and fused silica.

In various aspects, the membrane support can be a polymeric support. The polymeric support can be selected from polysulfone, polyethersulfone, poly(ether sulfone ketone), poly(ether ethyl ketone), poly(phthalazinone ether sulfone ketone), polyacrylonitrile, polypropylene, cellulose acetate, cellulose diacetate, or cellulose triacetate.

In various aspects, the membrane can further comprise one or more thin films disposed on the support. In a further aspect, the film can be an interfacially-polymerized polyamide matrix. The thin film can be a polyamide, a polyether, a polyether-urea, a polyester, or a polyimide, or a copolymer thereof or a mixture thereof The thin film can be a polyamide such as residues of phthaloyl halide, a trimesyl halide, or a mixture thereof and/or residues of diaminobenzene, triaminobenzene, or piperazine or a mixture thereof The thin film can be an aromatic polyamide such as residues of a trimesoyl halide and residues of diaminobenzene.

In various aspects, the membrane can be a microfiltration membrane. The membrane can have a pore size of from about 0.01 μM to about 5 μM, of from about 0.01 μM to about 4 μM, of from about 0.01 μM to about 3 μM, of from about 0.01 μM to about 2 μM, of from about 0.05 μM to about 5 μM, of from about 0.1 μM to about 5 μM, of from about 0.1 μM to about 4 μM, of from about 0.1 μM to about 3 μM, of from about 0.1 μM to about 2 μM, of from about 0.1 μM to about 1.8 μM, of from about 0.1 μM to about 1.6 μM, of from about 0.1 μM to about 1.4 μM, of from about 0.12 μM to about 1.4 μM, or of from about 0.14 μM to about 1.4 μM.

In various aspects, the membrane can be an ultrafiltration membrane. The membrane can have a pore size of from about 10 kDa to 500 kDa, of from about 10 kDa to 450 kDa, of from about 10 kDa to 400 kDa, of from about 10 kDa to 350 kDa, of from about 10 kDa to 300 kDa, of from about 11 kDa to 500 kDa, of from about 12 kDa to 500 kDa, of from about 13 kDa to 500 kDa, of from about 14 kDa to 500 kDa, of from about 15 kDa to 500 kDa, of from about 15 kDa to 450 kDa, of from about 15 kDa to 400 kDa, of from about 15 kDa to 350 kDa, or of from about 15 kDa to 300 kDa.

In various aspects, the membrane can be a nanofiltration membrane. The membrane can have a pore size of less than 10 kDa, of less than 9 kDa, of less than 8 kDa, of from about 1 kDa to about 8 kDa, of from about 2 kDa to about 8 kDa, of from about 4 kDa to about 8 kDa, or of from about 6 kDa to about 8 kDa.

In various aspects, the membrane can be a reverse osmosis membrane. The membrane can have a pore size of from about 0.0001 microns to about 0.001 microns, of from about 0.0001 microns to about 0.0007 microns, of from about 0.0001 microns to about 0.0005 microns, of from about 0.0001 microns to about 0.0003 microns, of from about 0.0002 microns to about 0.01 microns, of from about 0.0004 microns to about 0.01 microns, of from about 0.0006 microns to about 0.01 microns, or of from about 0.0008 microns to about 0.01 microns.

2. Light Source

In various aspects, the membranes of the invention comprise a light source disposed within the lumen of the tubular inorganic porous membrane. In a further aspect, the light source is an ultraviolet (UV) light. Suitable UV light sources can include, for example, mercury short arc lamps, xenon lamps, and LED's, and combinations thereof Other UV-emitting lamp types can also be used. In a still further aspect, the light source is an ultraviolet light selected from low pressure high output, vacuum ultraviolet and medium pressure. In yet a further aspect, the light source emits below 200 nm light.

In a further aspect, the light source is a visible light. Suitable visible light sources can include, for example, incandescent lamps, electroluminescent lamps, gas discharge lamps, and lasers, and combinations thereof Other visible light-emitting lamp types can also be used. In a still further aspect, the light source emits greater than 360 nm light.

In various aspects, the light source occupies at least 5 volume % of the total volume of the interior of the membrane. In a further aspect, light source occupies at least 10 volume % of the total volume of the interior of the membrane. In a still further aspect, the light source occupies at least 20 volume % of the total volume of the interior of the membrane. In an even further aspect, the light source occupies at least 30 volume % of the total volume of the interior of the membrane. In a still further aspect, the light source occupies at least 40 volume % of the total volume of the interior of the membrane. In yet a further aspect, the light source occupies at least 50 volume % of the total volume of the interior of the membrane. In an even further aspect, the light source occupies at least 60 volume % of the total volume of the interior of the membrane. In a still further aspect, the light source occupies at least 70 volume % of the total volume of the interior of the membrane. In yet a further aspect, the light source occupies at least 80 volume % of the total volume of the interior of the membrane. In an even further aspect, the light source occupies at least 90 volume % of the total volume of the interior of the membrane.

In various aspects, the light source extends at least 10% through the interior of the membrane. In a further aspect, the light source extends at least 20% through the interior of the membrane. In a still further aspect, the light source extends at least 30% through the interior of the membrane. In yet a further aspect, the light source extends at least 40% through the interior of the membrane. In an even further aspect, the light source extends at least 50% through the interior of the membrane. In a still further aspect, the light source extends at least 60% through the interior of the membrane. In yet a further aspect, the light source extends at least 70% through the interior of the membrane. In an even further aspect, the light source extends at least 80% through the interior of the membrane.

In various aspects, the light source decreases the volume of the interior of the membrane by at least 10%. In a further aspect, the light source decreases the volume of the interior of the membrane by at least 20%. In a still further aspect, the light source decreases the volume of the interior of the membrane by at least 30%. In yet a further aspect, the light source decreases the volume of the interior of the membrane by at least 40%. In an even further aspect, the light source decreases the volume of the interior of the membrane by at least 50%. In a still further aspect, the light source decreases the volume of the interior of the membrane by at least 60%. In yet a further aspect, the light source decreases the volume of the interior of the membrane by at least 70%. In an even further aspect, the light source decreases the volume of the interior of the membrane by at least 80%. In a still further aspect, the light source decreases the volume of the interior of the membrane by at least 90%.

In various aspects, the light source further comprises a light source sleeve.

In various aspects, the light source is optionally removable.

3. Displacement Body

In various aspects, the membranes of the invention comprise a displacement body disposed within the lumen of the tubular porous membrane. Suitable displacement bodies can include, for example, any hollow or solid component that serves to displace volume within the lumen of the membrane. As disclosed herein, a displacement body refers to any object that resides within the interior (e.g. lumen) of the membrane, thereby causing displacement of the fluid circulating within the membrane. In various aspects, a displacement body can be, for example, a second membrane.

In various aspects, the displacement body occupies at least 5 volume % of the total volume of the interior of the membrane. In a further aspect, the displacement body occupies at least 10 volume % of the total volume of the interior of the membrane. In a still further aspect, the displacement body occupies at least 20 volume % of the total volume of the interior of the membrane. In an even further aspect, the displacement body occupies at least 30 volume % of the total volume of the interior of the membrane. In a still further aspect, the displacement body occupies at least 40 volume % of the total volume of the interior of the membrane. In yet a further aspect, the displacement body occupies at least 50 volume % of the total volume of the interior of the membrane. In an even further aspect, the displacement body occupies at least 60 volume % of the total volume of the interior of the membrane. In a still further aspect, the displacement body occupies at least 70 volume % of the total volume of the interior of the membrane. In yet a further aspect, the displacement body occupies at least 80 volume % of the total volume of the interior of the membrane. In an even further aspect, the displacement body occupies at least 90 volume % of the total volume of the interior of the membrane.

In various aspects, the displacement body extends at least 10% through the interior of the membrane. In a further aspect, the displacement body extends at least 20% though the interior of the membrane. In a still further aspect, the displacement body extends at least 30% through the interior of the membrane. In yet a further aspect, the displacement body extends at least 40% through the interior of the membrane. In an even further aspect, the displacement body extends at least 50% through the interior of the membrane. In a still further aspect, the displacement body extends at least 60% through the interior of the membrane. In yet a further aspect, the displacement body extends at least 70% through the interior of the membrane. In an even further aspect, the displacement body extends at least 80% through the interior of the membrane.

In various aspects, the displacement body decreases the volume of the interior of the membrane by at least 10%. In a further aspect, the displacement body decreases the volume of the interior of the membrane by at least 20%. In a still further aspect, the displacement body decreases the volume of the interior of the membrane by at least 30%. In yet a further aspect, the displacement body decreases the volume of the interior of the membrane by at least 40%. In an even further aspect, the displacement body decreases the volume of the interior of the membrane by at least 50%. In a still further aspect, the displacement body decreases the volume of the interior of the membrane by at least 60%. In yet a further aspect, the displacement body decreases the volume of the interior of the membrane by at least 70%. In an even further aspect, the displacement body decreases the volume of the interior of the membrane by at least 80%. In a still further aspect, the displacement body decreases the volume of the interior of the membrane by at least 90%.

In various aspects, the displacement body decreases the volume of the interior of the membrane, thereby allowing for increased fluid flow without supplemental increases in pressure.

4. Cleaning Element

In various aspects, the membranes of the invention further comprise an annular cleaning element disposed between the membrane and the light source. Examples of suitable cleaning elements have been previously described (see, e.g., U.S. Pat. No. 4,198,293; U.S. Pat. No. 4,687,522; U.S. Pat. No. 4,255,255; U.S. Pat. No. 4,959,149). In a further aspect, the cleaning element is adapted to remove foulant from the membrane. In a still further aspect, the cleaning element is adapted to remove foulant from the light source or the light source sleeve. In yet a further aspect, the cleaning element is adapted to remove foulant from the membrane on one side, and simultaneously remove foulant from the light source on the other.

In various aspects, the cleaning element can have an average thickness of from about 0.7 to 1.4 times the inner diameter of the tubular membrane. In a further aspect, the cleaning element can have an average thickness of from about 0.8 to 1.4 times the inner diameter of the tubular membrane. In a still further aspect, the cleaning element can have an average thickness of from about 1.0 to 1.4 times the inner diameter of the tubular membrane. In yet a further aspect, the cleaning element can have an average thickness of from about 0.7 to 1.2 times the inner diameter of the tubular membrane. In an even further aspect, the cleaning element can have an average thickness of from about 0.7 to 1.0 times the inner diameter of the tubular membrane.

### C. METHODS OF MAKING A FILTRATION APPARATUS

In one aspect, the invention relates to a method of making a filtration apparatus, the method comprising disposing a light source within the lumen of a tubular inorganic porous membrane configured to receive an inflow liquid into the lumen, between the light source and the interior surface, and to produce an outflow liquid at the exterior surface from the inflow liquid passing through. Typical tubular ceramic membranes can be prepared, for example, by extrusion molding (see, e.g., U.S. Pat. No. 0,253,312; U.S. Pat. No. 0,164,641) or slip-casting (U.S. Pat. No. 6,528,214; U.S. Pat. No. 5,269,926).

In one aspect, the invention relates to a method for making a filtration apparatus, the method comprising disposing a displacement body within the lumen of a tubular porous membrane configured to receive an inflow liquid into the lumen, between the light source and the interior surface, and to produce an outflow liquid at the exterior surface from the inflow liquid passing through.

### D. METHODS FOR ENHANCING OXIDATION OF INORGANIC AND ORGANIC MOLECULES

In one aspect, the invention relates to a method for enhancing oxidation of organic molecules, the method comprising the steps of: (a) providing a disclosed filtration apparatus; (b) circulating the organic molecules in solution through the lumen of the filtration membrane, between the light source and the interior surface; and (c) irradiating the filtration membrane with the light source.

In one aspect, the invention relates to a method for enhancing oxidation of inorganic molecules, the method comprising the steps of: (a) providing a disclosed filtration apparatus; (b) circulating the inorganic molecules in solution through the lumen of the filtration membrane, between the light source and the interior surface; and (c) irradiating the filtration membrane with the light source.

Typically, oxidative processes rely on the generation of hydroxyl radicals (.OH) to degrade organic contaminants. The rapid, non-selective reactivity of hydroxyl radicals (one of the most reactive free radicals and strongest oxidants) allows them to act as initiators of oxidative degradation. In the oxidation, TiO₂/UV, for example, a titanium dioxide semiconductor absorbs UV light and generates hydroxyl radicals, mainly from adsorbed water or hydroxyl ions. Additional radicals, including free chlorine, nitrate, and hydrogen peroxide, have also demonstrated enhanced degradation of organic contaminants. In the case of membranes which generate a concentration polarization layer, other radicals, including halogenated radicals and singlet oxygen, may be produced.

Semiconductor photocatalysis can be used to mineralize most types of organic compounds such as, for example, alkanes, alkenes, haloalkanes, haloalkenes, aromatics, alcohols, haloaromatics, haloalcohols, acids, polymers, surfactants, nitroaromatics, dyes, pesticides, and explosives. The susceptibility of such a wide variety of compounds to this treatment makes photocatalytic degradation a particularly attractive process for cleaning of filtration apparatuses.

It is understood that the disclosed methods can be used in connection with the disclosed filtration apparatuses.

### E. METHODS FOR ENHANCING FOULANT REMOVAL

In one aspect, the invention relates to a method for enhancing foulant removal, the method comprising the steps of: (a) providing a disclosed filtration apparatus, wherein the membrane has a foulant layer on the surface; (b) loading a photocatalyst onto the foulant cake layer; (c) passing an inflow liquid through the lumen of the membrane, while circulating fluid between the light source and the interior support; and (d) irradiating the filtration membrane with the light source.

During phase separation techniques such as filtration, microfiltration, nanofiltration, and ultrafiltration, membrane elements are subject to fouling, wherein an unwanted layer builds up on the surface of the medium, resulting in marked deterioration of performance. Examples of foulants that can lead to the formation of a foulant layer include, for example, calcium carbonate scale, calcium sulfate scale, metal oxides scale, silica coating, and organic or biological deposits, and mixtures thereof.

The photocatalyst can be a porous titanium dioxide layer or surface formed on a porous membrane. The membrane may be made from virtually any material that can provide physical support for the photocatalyst material and is resistant to oxidation. Suitable materials can include, for example, a porous metal, porous carbon or graphite, a sintered porous glass, or a porous ceramic. The photocatalyst may be applied to the porous membrane by any means including: (1) applying a solution or slurry with a brush followed by sintering; (2) forming a sol-gel, applying the sol-gel by spraying, dipping, or spin coating, then drying and curing; (3) vacuum deposition processes, such as chemical vapor deposition and physical vapor deposition; or (4) electrochemical oxidation of a porous metal in an acid solution. The photocatalyst layer itself may be porous or, conversely, the photocatalyst may be a dense layer that simply leaves the pores of the membrane open.

In various aspects, the photocatalytic surface can have metal catalyst particles disposed therein. The metal catalyst can be a metal, metal oxide, or metal alloy, such as Pt group metals, Au group metals, Ir, Ru, Sn, Os, Mo, Zr, Cu, Nb, Rh, Pt—Sn, Pt—Mo, Pt—Ru, Ni—Zr, Pt—Rh, Pt—Ir, Pt—Ru—W, Pt—Ru—Os, Pt—Ru—Sn, Pt—Ni—Ti, Pt—Ni—Zr, Pt—Ni—Nb, platinum group metal oxides, gold group metal oxides, tin oxides, tungsten oxides, iridium oxides, rhodium oxides, and ruthenium oxides, and mixtures thereof.

### F. EXAMPLES

The following examples are put forth so as to provide those of ordinary skill in the art with a complete disclosure and description of how the apparatuses and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Proof of Concept Apparatus

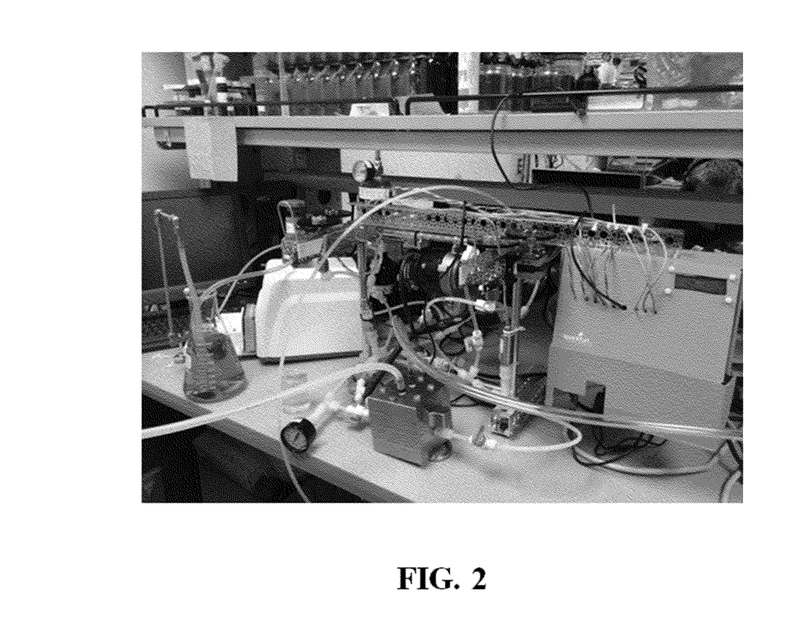

Proof of concept apparatus was a lamp mounted approximately 1 cm from a lens, mounted 1 cm from a 47 mm ceramic membrane. Untreated water entered the space between the lens and the membrane and was forced downward through the membrane by pressure. In select cases the system was operated such that water was tangentially passed across the membrane surface to induce surface shear (all water entering the reactor did not pass through the membrane but passed across the membrane surface). Flow and pressure were controlled by a ceramic piston pump, a back pressure valve, and automated mechanical flow control valves on the filtrate and the retentate. Flow was measured by determining the time between water droplets of known volume formed on the filtrate or retentate. This system is illustrated in FIG. 2.

2. In-Situ Cleaning

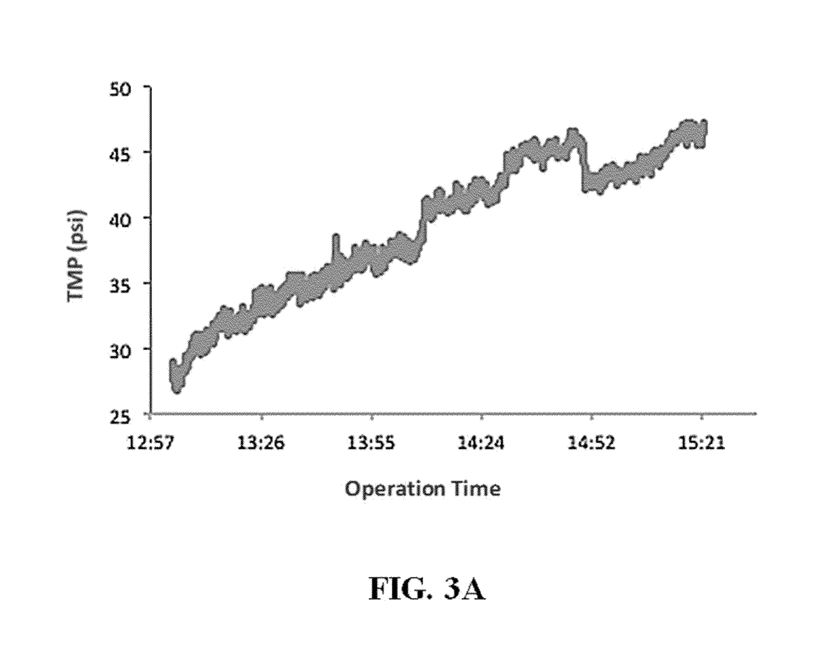

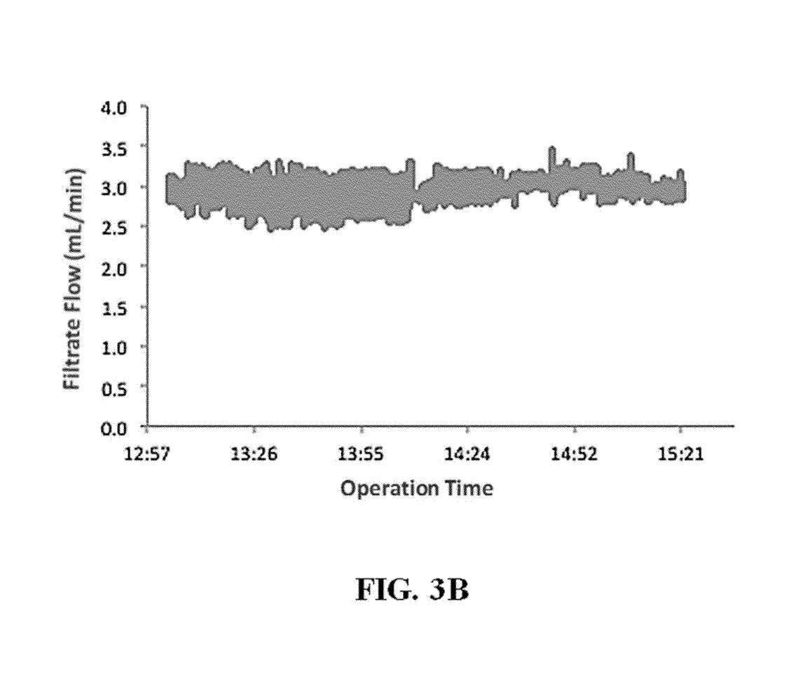

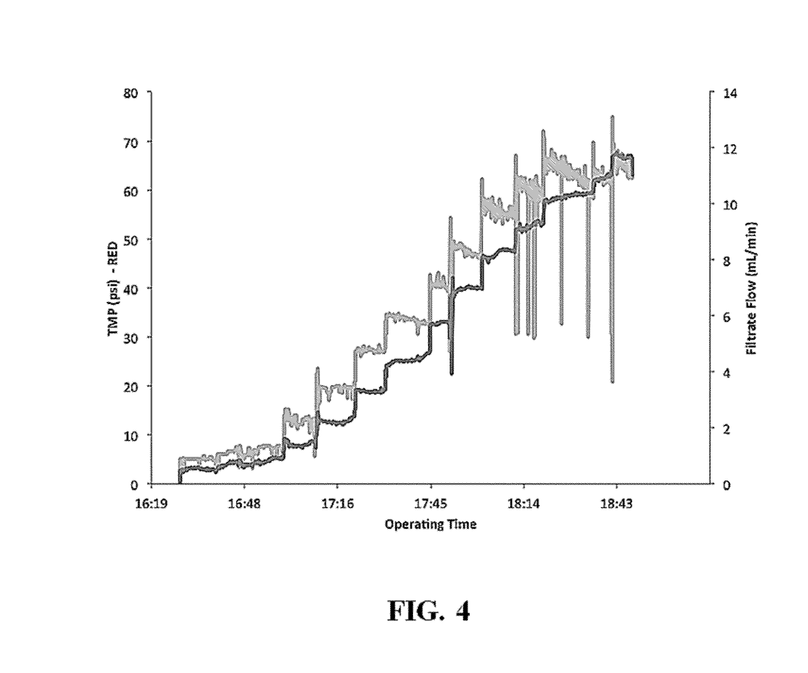

In-situ cleaning viability was probed using a high concentration of Aldrich Humic Acid dissolved in laboratory grade water (dissolved organic carbon concentration of approximately 5 mg-C/L). Feed solution was used to foul the membrane (as observed in FIGS. 3A and 3B) at constant flux. At 14:50 the vacuum ultraviolet lamp was powered on. Transmembrane pressure was monitored about every 2 seconds. Successful observation was made if progression of increase in transmembrane pressure was halted or reversed upon turning the lamp on.

3. Flux Maintenance

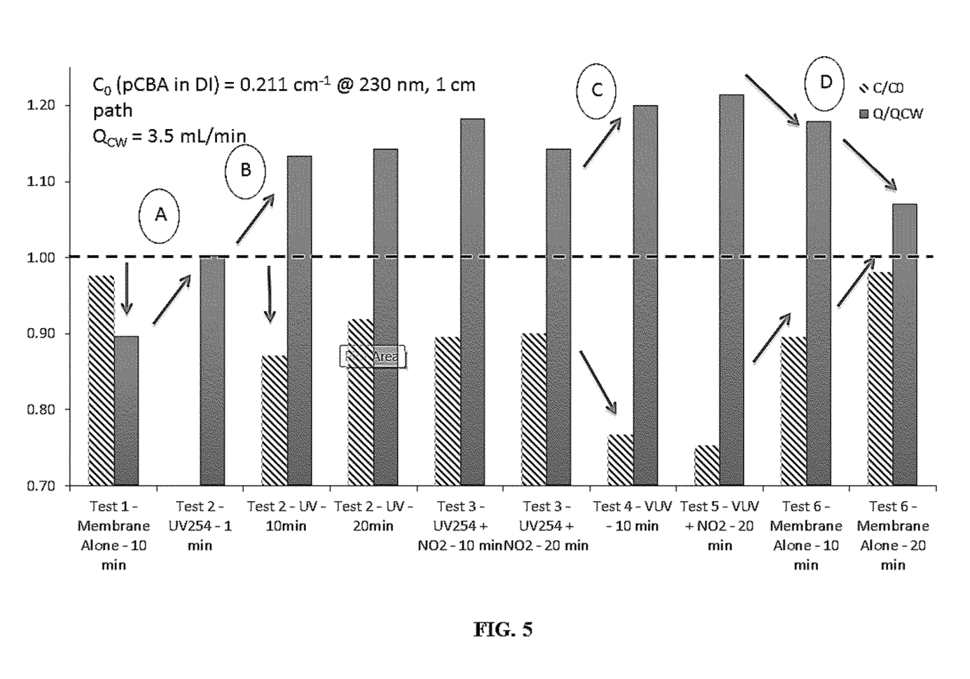

Flux maintenance was inferred and observed through maintained clean water flux evaluation performed in the background of testing presented in FIG. 5, as well as observation of decline in transmembrane pressure during in-situ cleaning experiment. It can be inferred that due to the decrease in transmembrane pressure during the in-situ cleaning experiment, operation of the lamp throughout all operation would extend operating life of the membrane through constant oxidation of selected foulants.

4. Decay of Organic Pollutants

Organic pollutant degradation was observed in experiments performed using parachlorobenzoic acid (p-CBA) in laboratory grade water at a concentration equivalent to an ultraviolet absorbance of 0.211 cm⁻¹ at 230 nm in a 1 cm path length cell. Test procedure followed the conditions as presented in the x-axis of FIG. 5. Observation of fouling was measured as change in transmembrane pressure in comparison to that noted during the identification of clean water flux (TMP_{[test]}/TMP₀) and p-CBA decay as change in ultraviolet absorbance at 230 nm as compared to initial concentration (p-CBA_{[test]}/p-CBA₀). Between each experiment system was allowed to equilibrate for approximately 15 reactor volumes to ensure test conditions were those being measured.

Referring to FIG. 5, the solid bars indicate trends in flow (i.e., flux) and the striped bars indicate trends in pollutant degradation. Minor fouling was observed after measurements of clean water flux and negligible pollutant degradation (A). Flux recovery and increased flux were observed with UV germicidal (254 nm on) and pollutant degradation was measurable at approximately 10% (B). Continued flux increase was observed with VUV (185 and 285 nm) as well as further pollutant decay (approximately 25%) (C). Additionally, when returned to no UV or VUV flux decline was again observed. Pollutant concentration approached that of the feed container (D).

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A filtration apparatus comprising:
(a) a tubular inorganic porous membrane having an interior surface, an exterior surface, and a lumen extending therethrough; and
(b) a light source disposed within the lumen of the tubular inorganic porous membrane;
wherein the membrane is configured to receive an inflow liquid into the lumen, between the light source and the interior surface; and
wherein the membrane is configured to produce an outflow liquid at the exterior surface from the inflow liquid passing through.

2. The apparatus of claim 1, wherein the membrane is ceramic.

3. The apparatus of claim 1, wherein the membrane is classified as a nanofiltration, an ultrafiltration, or a microfiltration membrane.

4. The apparatus of claim 1, further comprising an annular cleaning element disposed between the membrane and the light source.

5. The apparatus of claim 4, wherein the cleaning element is adapted to remove foulant from the membrane.

6. The apparatus of claim 4, wherein the cleaning element is adapted to remove foulant from the light source.

7. The apparatus of claim 4, wherein the cleaning element is adapted to
(a) remove foulant from the membrane; and
(b) remove foulant from the light source.

8. A filtration apparatus comprising:
(a) a tubular porous membrane having an interior surface, an exterior surface, and a lumen extending there through; and
(b) a displacement body disposed within the lumen of the tubular porous membrane;
wherein the membrane is configured to receive an inflow liquid into the lumen, between the displacement body and the interior surface; and
wherein the membrane is configured to produce an outflow liquid at the exterior surface from the inflow liquid passing through.

9. The apparatus of claim 8, wherein the membrane is ceramic.

10. The apparatus of claim 8, wherein the membrane is polymeric.

11. The apparatus of claim 8, wherein the displacement body is a light source.

12. The apparatus of claim 8, further comprising an annular cleaning element disposed between the membrane and the displacement body.

13. The apparatus of claim 12, wherein the cleaning element is adapted to remove foulant from the membrane.

14. The apparatus of claim 12, wherein the cleaning element is adapted to remove foulant from the light source.

15. The apparatus of claim 12, wherein the cleaning element is adapted to
(a) remove foulant from the membrane; and
(b) remove foulant from the light source.

16. A method for making a filtration apparatus, the method comprising disposing a displacement body within the lumen of a tubular porous membrane configured to receive an inflow liquid into the lumen, between the light source and the interior surface, and to produce an outflow liquid at the exterior surface from the inflow liquid passing through.

17. A method for enhancing oxidation of organic molecules, the method comprising the steps of:
(a) providing a filtration apparatus comprising:
(i) a tubular inorganic porous membrane having an interior surface, an exterior surface, and a lumen extending therethrough; and
(ii) a light source disposed within the lumen of the tubular inorganic porous membrane;
wherein the membrane is configured to receive an inflow liquid into the lumen, between the light source and the interior surface; and
wherein the membrane is configured to produce an outflow liquid at the exterior surface from the inflow liquid passing through;
(b) circulating the organic molecules in solution through the lumen of the filtration membrane, between the light source and the interior surface; and
(c) irradiating the filtration membrane with the light source.

18. A method for enhancing oxidation of inorganic molecules, the method comprising the steps of:
(a) providing a filtration apparatus comprising:
(i) a tubular inorganic porous membrane having an interior surface, an exterior surface, and a lumen extending therethrough; and
(ii) a light source disposed within the lumen of the tubular inorganic porous membrane;
wherein the membrane is configured to receive an inflow liquid into the lumen, between the light source and the interior surface; and
wherein the membrane is configured to produce an outflow liquid at the exterior surface from the inflow liquid passing through;
(b) circulating the inorganic molecules in solution through the lumen of the filtration membrane, between the light source and the interior surface; and
(c) irradiating the filtration membrane with the light source.

19. A method for enhancing foulant removal, the method comprising the steps of:
(a) providing a filtration apparatus comprising:
(i) a tubular inorganic porous membrane having an interior surface, an exterior surface, and a lumen extending therethrough; and
(ii) a light source disposed within the lumen of the tubular inorganic porous membrane;
wherein the membrane is configured to receive an inflow liquid into the lumen, between the light source and the interior surface;
wherein the membrane is configured to produce an outflow liquid at the exterior surface from the inflow liquid passing through; and
wherein the membrane has a foulant layer on the surface;
(b) loading a photocatalyst onto the foulant layer;
(c) passing an inflow liquid through the lumen of the membrane, while circulating fluid between the light source and the interior support; and
(d) irradiating the filtration membrane with the light source.

20. The method of claim 19, wherein the photocatalyst is TiO₂.
